(19) United States
(12) Patent Application Publication
(10) Pub. No.: US 2005/0015557 A1
(43) Pub. Date: Jan. 20, 2005

(54) Nonvolatile memory unit with specific cache

(76) Inventors: Chih-Hung Wang, Yunlin Hsien (TW); Chun-Hao Kuo, Shinchu (TW); Chun-Hung Lin, Hsinchu Hsien (TW)

Correspondence Address: JC Patents Inc, Suite 250, 4 Venture, Irvine, CA, 92618, US

(21) Appl. No.: 10/477,783

(22) PCT Filed: Dec. 27, 2002
(86) PCT No.: PCT/IB02/05615

(51) Int. Cl. G06F 12/08

(52) U.S. Cl. 711/154; 711/118; 711/103; 711/203

(57) ABSTRACT

The invention provides a method for organizing a writing operation to a nonvolatile memory. The method comprises setting a specific cache area, into which a specific data belonging to a specific group of logical blocks is to be written. It is determined whether or not the writing operation is a random write. If the writing operation is the random write, then the following steps are performed: determining whether or not the writing operation is to write a data that is belonging to the specific group of logical blocks; and writing the data into the specific cache area if the data is belonging to the specific group of logical blocks. As a result, a swap action between a data block and a writing block can be avoided during a random write operation. A storage structure in a nonvolatile memory device are organized to perform the forgoing writing operation.

### BACKGROUND OF THE INVENTION

1. Field of Invention

The present invention relates to digital data storage systems using a non-volatile memory device. More particularly, the present invention relates to the non-volatile memory unit including a specific cache, such as a FAT cache, so as to reduce the frequency for swapping action during writing data into the non-volatile memory unit.

2. Description of Related Art

Although hard disk drives are widely used in current computer system, the hard disk still has several deficiencies such as rotation and high power consumption, in which consumption magnetic mass storage devices, like an inherent latency during accessing the hard disk drives, high power consumption, being unable to withstand the physical shock, and having a large weight for portable computer devices. A non-volatile memory mass storage device, like a flash memory disk drive, is a nice choice for replacing a hard disk. Each memory mass storage device always comprises two portions. One is a controller part, and the other is memory module. The semiconductor technology allows such a memory storage device to withstand many of the kinds of physical shock and reduce power consumption or weight. These flash memory storage devices are also widely used and accepted for all the current computer devices, like desktop PC, laptop, PDA, DSC, and so on.

Nonvolatile memory chips, which include nonvolatile memory arrays, have various applications for storing digital information. One such application is for storage of large amounts of digital information for use by digital cameras, as replacements for hard disk within personal computer (PCs) and so forth. Nonvolatile memory arrays are comprised of various types of memory cells, such as NOR, NAND and other types of structures known to those of ordinary skill in the art that have the characteristic of maintaining information stored therein while power is disconnected or disrupted.

In those various kinds of nonvolatile memory chips, flash memories have advanced performances in accessing data, than any other kind of nonvolatile memories for a reading and writing (or programming). The merit of high speed operation in the flash memory has been regarded to be very adaptable to portable computing apparatuses, cellular phones or digital still cameras.

FIG. 1 is a block diagram, schematically illustrating architecture of flash memory card. In FIG. 1, the host end 100 can access data stored in a flash disk 102, in which the flash disk 102 includes a control unit 104 and a memory unit 106. A memory unit may include one or more memory chips. In access operation, the host end 100 usually accesses the data in the memory module 106 via the control unit 104 at the requested address. In addition to communicating with the host, the control unit also takes responsibility of managing the memory unit. The flash memory storage device is then configured as a drive by the host through a mapping table. FIG. 2 is a mapping table. From the host point of view, such a drive includes a plurality of logical blocks 108, each of which can be addressed by the host. Namely, the host can access all the logical space including logical block 0, logical block 1, and logical block M−1.

A flash memory chip generally is divided into a plurality of storage units, like blocks which include one or more sectors. As shown in FIG. 2, the physical space of the flash memory module includes physical block 0, physical block1, . . . , and physical block N−1. The logical space used by the host is always less than the physical space, because some of the physical blocks may be defective or used by the controller for managing the flash memory module. One task of the controller is to create the logical space for host access. Indeed, the host can not directly address the physical space so that the controller must maintain the mapping relations between the logical blocks and the physical blocks. Such a mapping information is always called as a mapping table and can be stored in the specific physical blocks or loaded into the SRAM within the controller. If a host asks for reading a particular logical block, the controller will look up the mapping table for identifying which physical block to be accessed, transfer data from the physical block to itself, and then transfer data from itself to the host.

FIG. 3A is a drawing, schematically the conventional mapping architecture. The data block and writing block are formed and managed by the control unit. Each of them includes at least one physical block. In FIG. 3A, the logical block 300 is used by the host to write a data into the data block 302. However, since the overhead arises from erase-then-program architecture, when the data will be re-written into the data block 302, the data is temporarily written to a writing block 304. When the writing block 304 is, for example, fully written, then a swap action between the data block 302 and the write block 304 are necessary. FIG. 3B is a drawing, schematically illustrating how to recycle these blocks. The swap operation generally means that the writing block replaces the data block. However, the replaced data block can be considered as an old block so that it will be erased and then become a spare block. The spare block can be allocated out and become a writing block if the control unit needs such a writing block for the host write request.

With respect to the data block or the writing block, a sector structure is shown in FIG. 4. In one sector, it usually includes a data area 400, such as a size of 512 byte, and an extra area 402, which may include the information of logical block number, system flag, error correction code (Ecc), and so on. FIG. 5 is a drawing, schematically illustrating the mapping relation between the logic block 300, the data block 302 and the spare block 304. In FIG. 5, the logical block No. 0 maps to the data block 302 whose physical Block number is 5, and the spare block 304 is located at physical block No. 200h. The mapping table is divided into the logical area and the physical area. For example, the first row shows that the logical block No. 0 is with respect to the data block No. 5, and the spare block No. 200h can be allocated to become a writing block for any one data block. If host asks for writing sector LBA0 now, then the spare block will be allocated to become a writing block, as shown in FIG. 6. Moreover, a sector LBA0 will be written into the first position in the writing block. Now, the field for the first empty logical sector is filled by 1, which means that the first sector of the empty sectors in the write block 304 is starting at LBA 1.

FIG. 7 is a drawing, schematically illustrating a data mapping relation after a swap action. Referring to FIG. 6, if the sector LBA0 is to be written again, then a swap action is necessary in the conventional method. Because of the flash characteristic, we can not directly write data into current writing block 304 whose physical block No. is 200h so that a swap operation is needed. The swap operation we have to do now is time-consuming and reduces the system performance. All the sectors except LBA 0 in data block must be moved to the current writing block, and then the original data block (physical No. 5) will be erased so that the current writing block (physical No. 200) becomes the data block, as in FIG. 7. After swap operation, we still need a writing block for the LBA 0 write operation. We can use the just erased physical block No. 5 as the current writing block. Also, we can use the other spare block as the current writing block. Eventually, the LBA 0 data will be written into the current logical block and the mapping table should be updated, as FIG. 7. Here, this kind of situation for writing is called a random write.

FIG. 8, is a block diagram, schematically illustrating a control mechanism between a host side and a controller side in writing operation. In FIG. 8, at the host side, it includes a file handling 800 and a logical sector handling 802. The host side communicates with the control side via an interface. The controller side includes a mapping table and a write algorithm 804, and a physical sector handling 806.

For the actual file writing operation, an example is shown in FIG. 9. A flash disk logical spare 808, composed of multiple sectors (not shown), can be partitioned by a normal operation system, like DOS. The structure of DOS partition includes BPB locating at logical sector 20h, FAT1 area starting at logical sector 21h, FAT 2 area starting at logical sector 9ch, root directory area starting at 117H, and data area starting at 137H. The DOS partition location is not fixed and always depends on the disk capacity. For a host that wants to write a file into a disk, the behavior of file handling generally includes five steps. Step 1, the host writes a directory entry into a directory, like root directory. Step 2, the host writes data into data area. Step 3, the host writes data into FAT 1 area. Step 4, the host writes data into FAT 2 area. Step 5, eventually, the host write the directory entry into the directory again. The behavior of file handling results in the behavior logical sector handling. The logical sector handling includes step 1, writing a logical sector, step 2, always writing a lot of sequential logical sectors, step 3, random writing some logical sectors, step 4, random writing some logical sectors as well, step 5, random re-writing a logical sector. According to the prior art write algorithm, only one writing block serves as a temporary block for a specific data block, and such a logical sector handling for writing a file generally results in at least three swap operations, included in step 3, step 4, and step 5 during implementing the conventional write algorithm.

Since the swap action between the data block and the writing block consumes more cycle time, this would seriously reduced the writing speed. Therefore, how to organize the writing operation for the nonvolatile memory unit, such as the flash memory, and improve the writing performance is still under investigated and developed, so as to solve the conventional issues.

### SUMMARY OF THE INVENTION

One of the objectives in the present invention is to reduce the frequency of swap operation when a random write occurs by introducing a specific cache area and a directory cache area, when the data belonging to the two specific types are to be written.

The invention provides a method for organizing a writing operation to a nonvolatile memory. The method comprises setting a specific cache area, into which a specific data belonging to a specific group of logical blocks is to be written. It is determined whether or not the writing operation is a random write. If the writing operation is the random write, then the following steps are performed: determining whether or not the writing operation is to write a data that is belonging to the specific group of logical blocks; and writing the data into the specific cache area if the data is belonging to the specific group of logical blocks. As a result, a swap action between a data block and a writing block can be avoided during a random write operation.

The invention provides another method for organizing a writing operation to a nonvolatile memory. The method comprises setting a specific cache area. It is determined whether or not the writing operation is a random write. If the writing operation is the random write, then the following steps are performed: determining whether or not a sector count of a data to be written is less than a predetermined number; and writing the data into the specific cache area if the sector count of the data is less than the predetermined number. Wherein, a swap action between a data block and a writing block can be avoided during a random write operation.

The invention further provides a method for organizing a writing operation to a nonvolatile memory. The method comprises setting a specific cache area. It is determined whether or not the writing operation is a random write. If the writing operation is the random write, then the following steps are performed. It is determined whether or not the writing operation is to write a data that is belonging to the specific group of logical blocks. The data is written into the specific cache area if the data is belonging to the specific group of logical blocks. It is determined whether or not a sector count of the data to be written is less than a predetermined number. The data is written into the specific cache area if the sector count of the data is less than the predetermined number. Wherein, a swap action between a data block and a writing block can be avoided during a random write operation.

The invention also provides a storage structure of a nonvolatile memory unit within a memory storage device which can be accessed by a host. The nonvolatile memory unit included a plurality of physical blocks, used and managed by a control unit within the memory storage device. The control unit organizes the physical blocks into a plurality of types of block, comprising a data block, a writing block, and at least one specific cache area. Also and, a spare block can be optionally included. The data block is composed of at least one physical block, and used to store a corresponding logical block information. The writing block serves as a temporary block for the data block. The spare block is allocated to become the writing block. The specific cache area is used for writing-into a cached data, wherein the cached data includes a specific data belonging to a specific logical block, whereby a swap action for this time of writing the specific data is not always necessary even if a random write is desired.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a block diagram, schematically illustrating architecture of flash memory card;

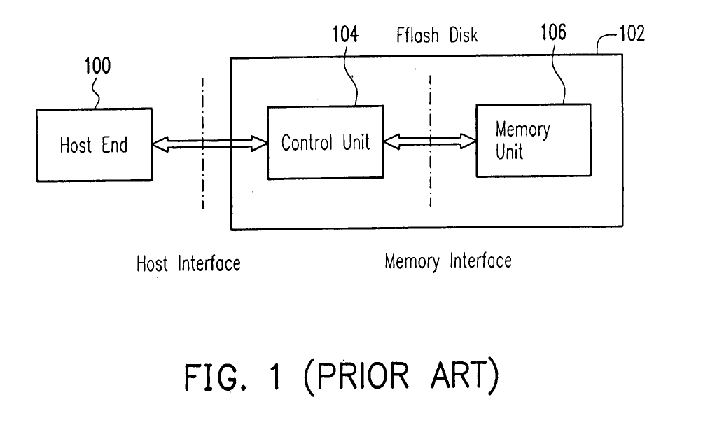

FIG. 2 is a conventional mapping table;

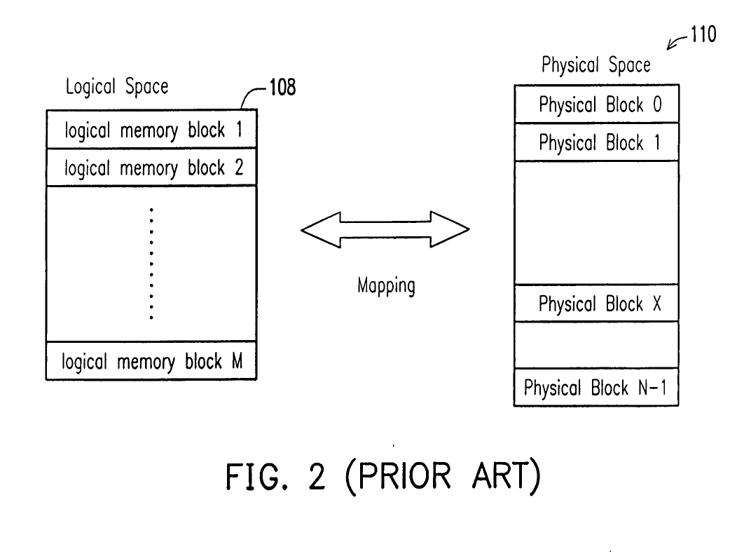

FIG. 3A-3B is a drawing, schematically the conventional mapping architecture and the swap algorithm;

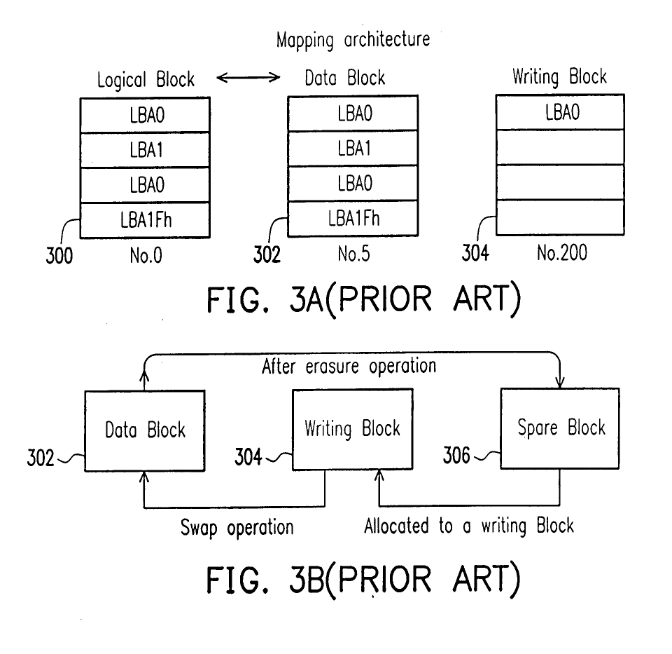

FIG. 4 is a conventional sector structure;

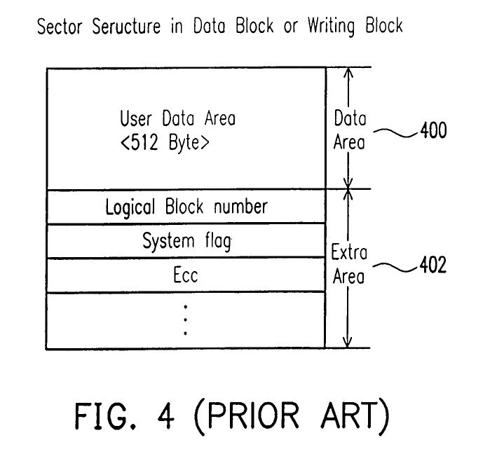

FIG. 5 is a drawing, schematically illustrating the mapping relation between the logical block, the data block and the spare block;

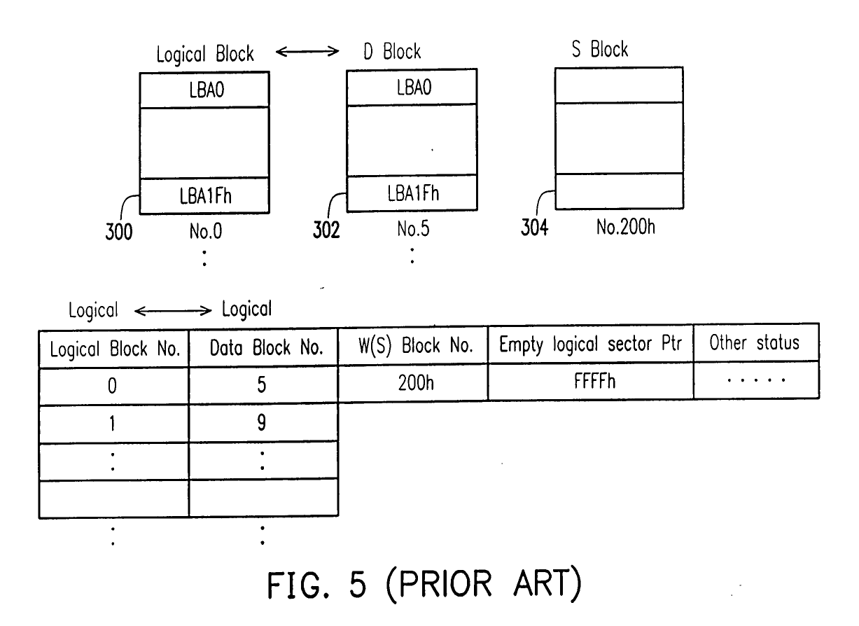

FIG. 6 is a drawing, schematically illustrating a writing operation indicated by the mapping table;

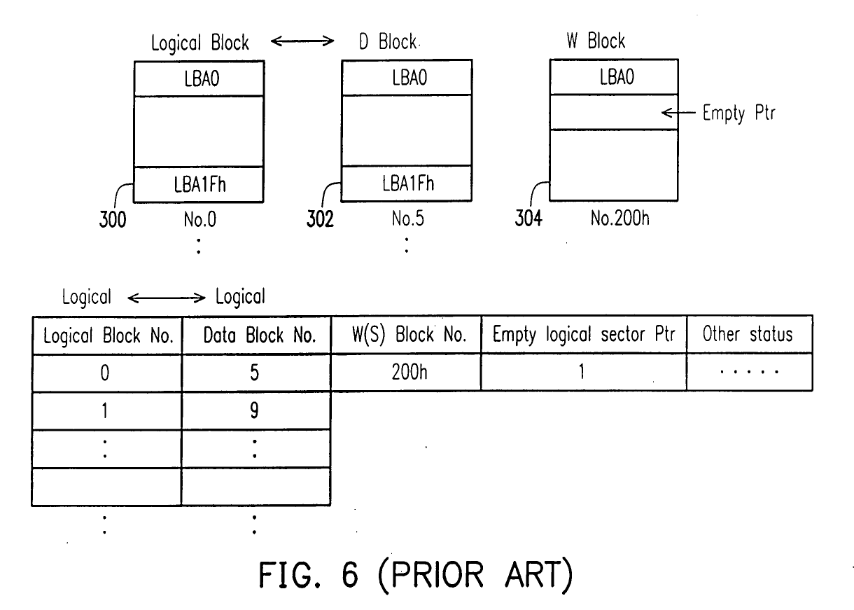

FIG. 7 is a drawing, schematically illustrating a data mapping relation after a swap action;

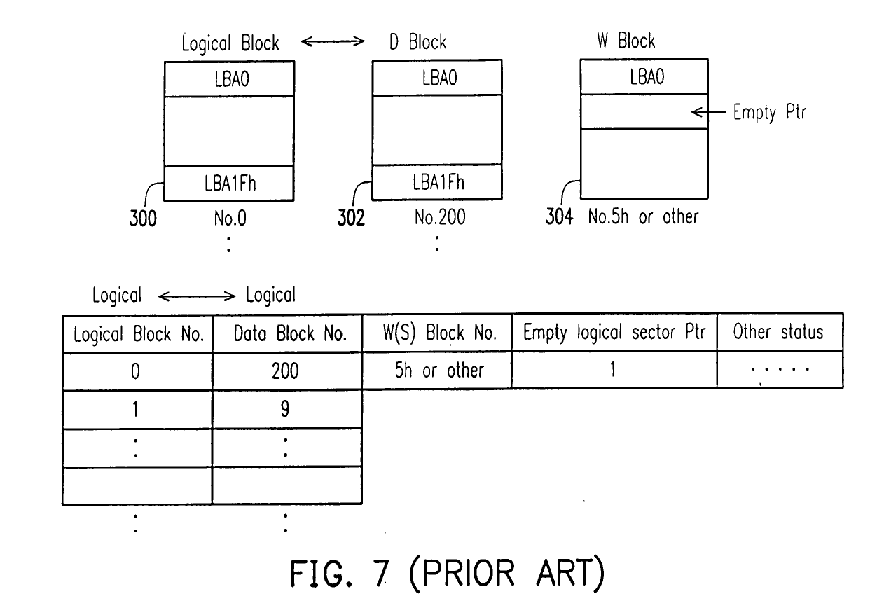

FIG. 8 is block diagram, schematically illustrating a control mechanism between a host side and a controller side in writing operation;

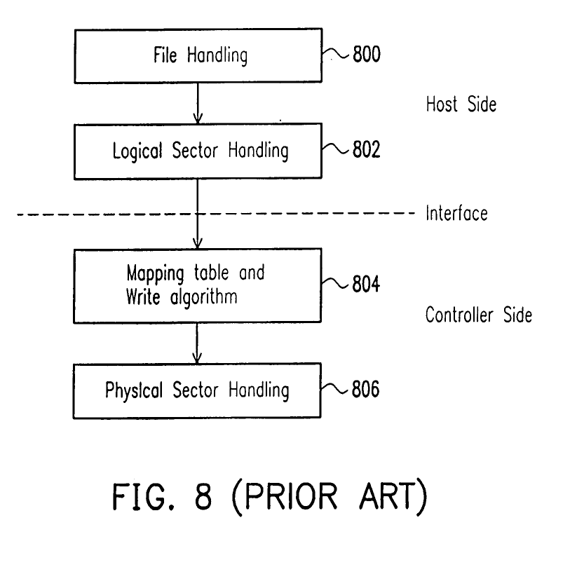

FIG. 9 is a drawing, schematically illustrating an actual file write operation;

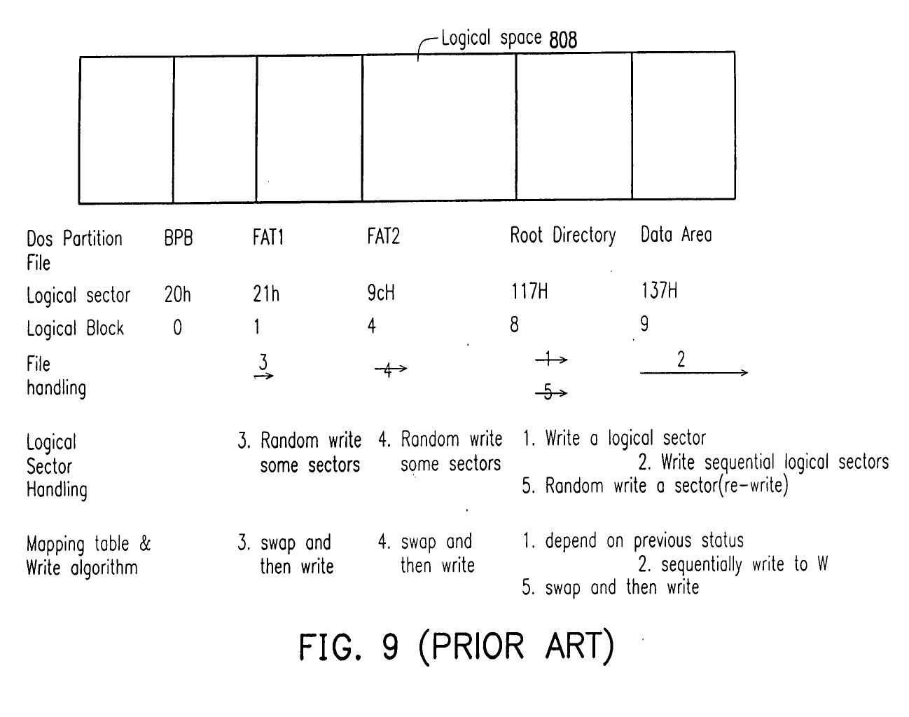

FIG. 10 is a drawing, schematically illustrating a file write operation for a 32 MB flash card.

FIG. 11 is a drawing, schematically illustrating a FAT or a directory cache structure, according to one preferred embodiment of this invention;

FIG. 12 is a process flow diagram schematically illustrating the method to write a data into the FAT cache or the corresponding cache, according to one preferred embodiment of this invention;

FIG. 13 is a process flow diagram schematically illustrating the method to write a data into the directory cache, according to one preferred embodiment of this invention.

FIG. 14 is a combined process flow diagram, schematically illustrating the method to write a data with reduced time of swap action, according to one preferred embodiment of this invention;

FIG. 15 is a drawing, schematically illustrating a status of the directory cache, according to one preferred embodiment of this invention; and

FIG. 16 is a drawing, schematically illustrating a status of the FAT cache or the corresponding cache, according to one preferred embodiment of this invention.

### DESCRIPTION OF THE PREFERRED EMBODIMENTS

One of the features of the present invention is to reduce the frequency of swap action when a random write is required to the nonvolatile memory unit within the memory storage device. After inspecting the types of random write, the present invention found that the random write resulting in a swap action will always occur when the host writes FAT or directory information into the memory storage device during file access. The present invention then propose to create a specific cache area, which can include, for example, the FAT cache for storing the FAT-like information, the directory cache for storing the directory-like information, or other corresponding cache for storing data belonging to a specific logical sector or logical block. Each FAT or directory cache is comprised of at least one physical block. As a result, some kinds of random write will not be necessary to take the swap action in each time of data write. Then, the data writing speed can be effectively improved. An example is provided for the descriptions of the invention as follows:

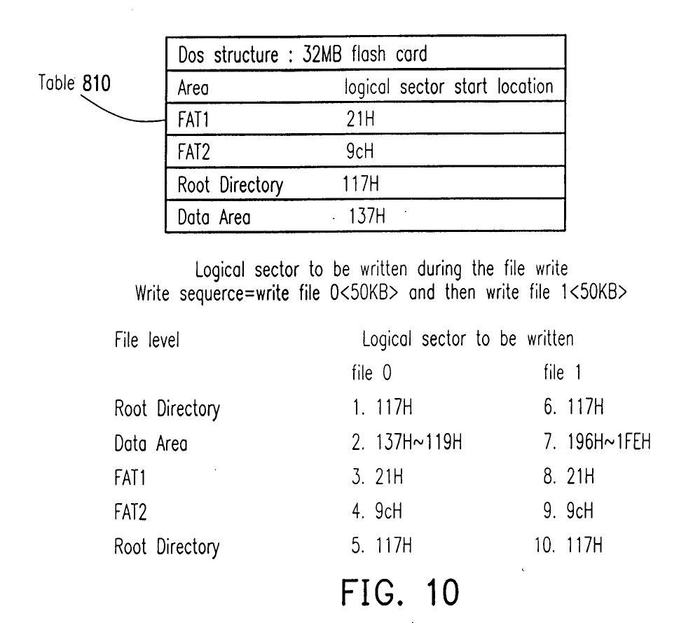

FIG. 10 is a drawing, schematically illustrating a file write operation for a 32 MB flash card. The DOS structure table 810 points out the logical sector start address for each area. It is supposed that a file <file 0> with a size of 50 k bytes is written into a flash card first, and then, a same size file <file 1> is written into a flash card as well. In this manner, there are 10 times of writing action to write the files of <file 0> and <file 1>. If the last one written logical sector is not LBA 116H, the write steps of 1, 3-6, and 8-10 are random writes. In the convention method, each time of the random write will cause a swap action. According to the present invention, the writing steps of 1, 5, 6 and 10 will be written into a directory cache and the writing steps of 3, 4, 8, and 9 will be written into the FAT cache. Here, only the FAT cache area and the directory cache area are used as the example but not the only limitation of the invention.

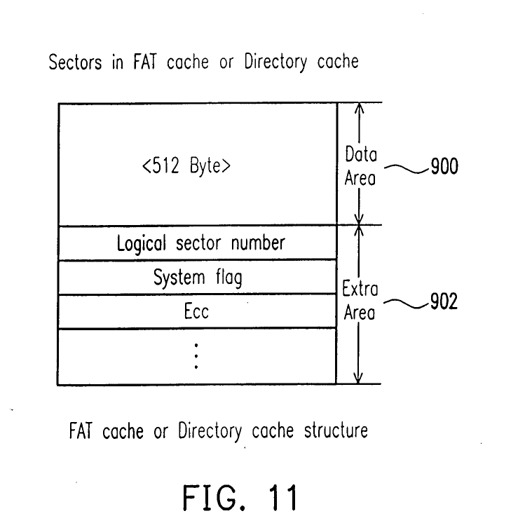

FIG. 11 is a drawing, schematically illustrating a FAT or a directory cache structure, according to one preferred embodiment of this invention. In FIG. 11 the structure in the FAT cache or the directory cache can be, for example, the same. It usually includes the user data area 900 and the extra area 902 including logical sector number, system flag, and ECC. The invention introduces this kind of specific cache area, so as to reduce the frequency of performing the swap action during writing data into the nonvolatile memory.

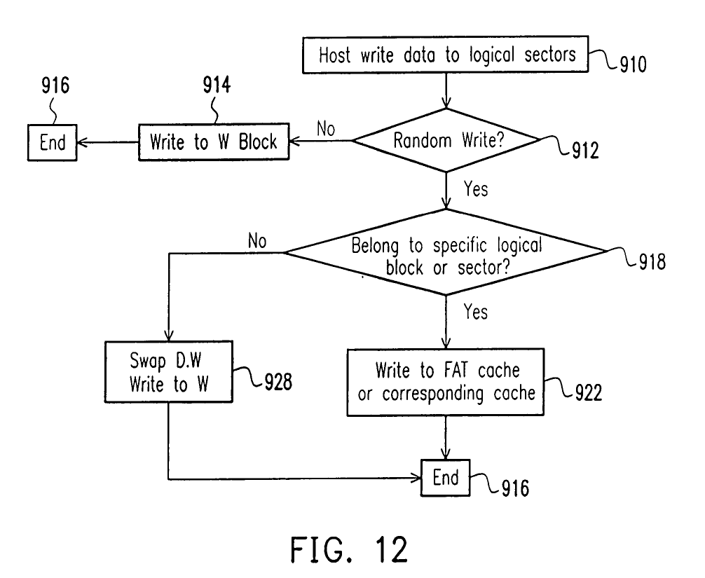

FIG. 12 is a process flow diagram, schematically illustrating the method to write a data into the FAT cache or corresponding cache with reduced the times of swap action, according to one preferred embodiment of this invention. In FIG. 12, a writing procedure is provided as an example, according to the features of the present invention. In step 910, the host intends to write a data to logical sector. After receiving the host request for writing data, the control unit will judge whether it is a random write or not. Generally, the random write means the logical sector to be written is not the next one of the last one logical sector previously written. In step 912, if it is not a random write, then the data can be directly written into the writing block (step 914) according the prior art write operation and the process goes to an end (step 916). If it is a random write, then the procedure goes to the step 918 to check whether or not the data is belonging to one or more specific logical blocks or logical sectors. In our one preferred embodiment of this invention, the specific logical blocks can be set as logical block number 1 and logical block number 4, because these two logical blocks can contain portions of FAT1 or FAT2 area as shown in FIG. 10. The data in the specific logical block we defined may be not the real FAT data, like the BPB data within the logical block number 1 due to DOS structure. However, such a way can store most of real FAT data into FAT cache and reduce the times for swap action. Namely, the FAT cache is for storing FAT-like data. If it is yes in step 918, then the data is written into the FAT cache in step 922. Then, the writing procedure goes to the end, in step 916. If it is no in step 918, the writing procedure goes to the step 928, to perform a swap action and writing data into the new allocated write block. After then, the writing procedure goes to the end (step 916). It is noted that such a concept for storing FAT-like data into FAT cache can be used for storing a data belonging to a specific logical block or sectors, into a corresponding cache.

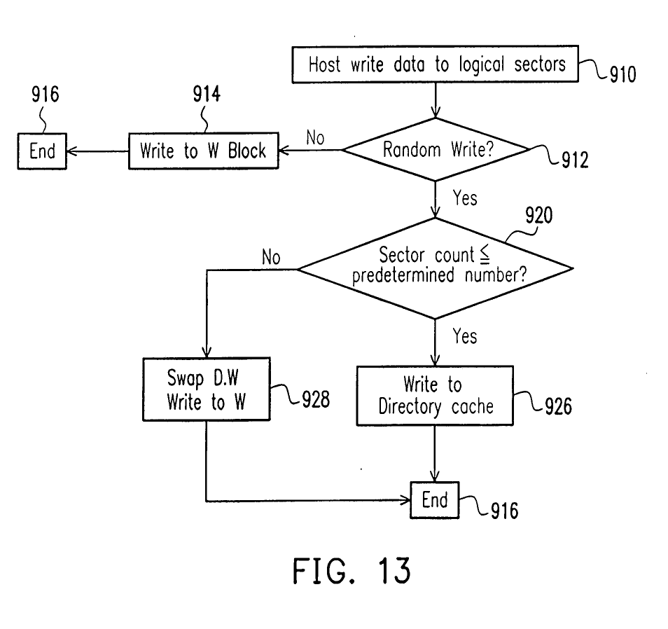

FIG. 13 is a process flow diagram, schematically illustrating the method to write a data into the directory cache with reduced the times of swap action, according to one preferred embodiment of this invention. In FIG. 13, a writing procedure is provided as an example, according to the features of the present invention. In step 910, the host intends to write a data to logical sector. After receiving the host request for writing data, the control unit will judge whether it is a random write or not. In step 912, if it is not a random write, then the data can be directly written into the writing block (step 914) according the prior art write operation and the process goes to an end (step 916). If it is a random write, then the procedure goes to the step 920 to check whether or not the sector counter of total data is less than a predetermined number. If it is yes in step 920, then the data will be written into the directory cache, in step 926. Eventually, the procedure goes to the end, step 916. In one preferred embodiment of this invention, the predetermined number is, but not limited to 5. The reason why we need to set a predetermined number is that the host generally writes a small sector count for storing the directory entry into directory. In fact, the different host behavior may change so that the data stored into directory cache may be not the directory data. However, such a way can reduce the times of swap action. If it is no in step 920, the writing procedure goes to the step 928, to perform a swap action and writing data into the new allocated write block. After then, the writing procedure goes to the end (step 916).

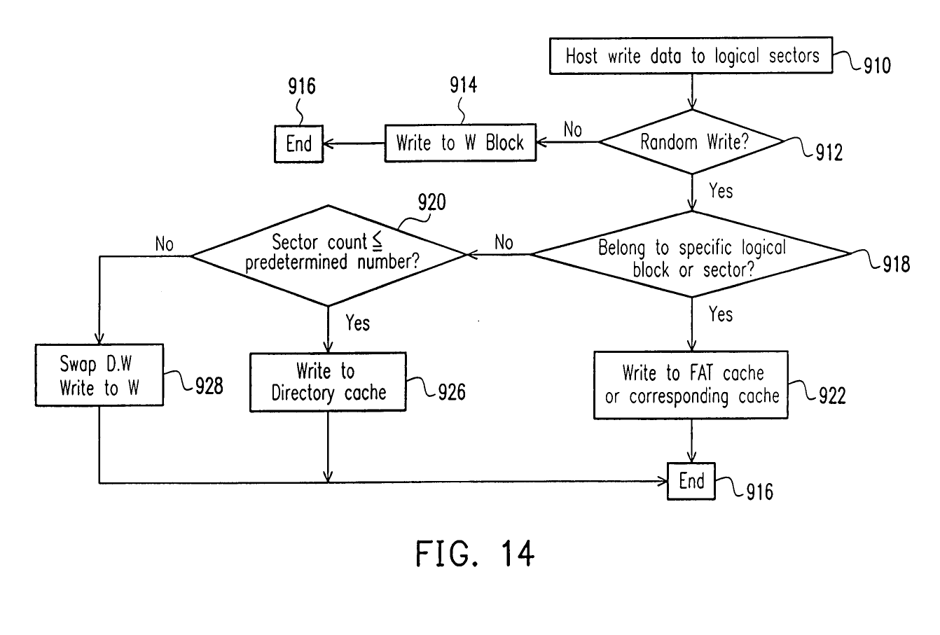

FIG. 14 is a combined process flow diagram, schematically illustrating the method to write a data into the FAT cache or the directory cache with reduced the times of swap action, according to one preferred embodiment of this invention. In FIG. 14, a writing procedure is provided as an example, according to the features of the present invention. In step 910, the host intends to write a data to logical sector. After receiving the host request for writing data, the control unit will judge whether it is a random write or not. In step 912, if it is not a random write, then the data can be directly written into the writing block (step 914) according to the prior art write operation and the process goes to an end (step 916). If it is a random write, then the procedure goes to the step 918 to check whether or not the data is belonging to one or more specific logical blocks or logical sectors. If it is yes in step 918, then the data is written into the FAT cache, in step 922. Then, the writing procedure goes to the end, in step 916. If it is no in step 918, the procedure goes to step 920. If it is yes in step 920, then the data will be written into the directory cache, in step 926. Eventually, the procedure goes to the end, step 916. If it is no in step 920, the writing procedure goes to the step 928, to perform a swap action and writing data into the new allocated write block. After then, the writing procedure goes to the end (step 916).

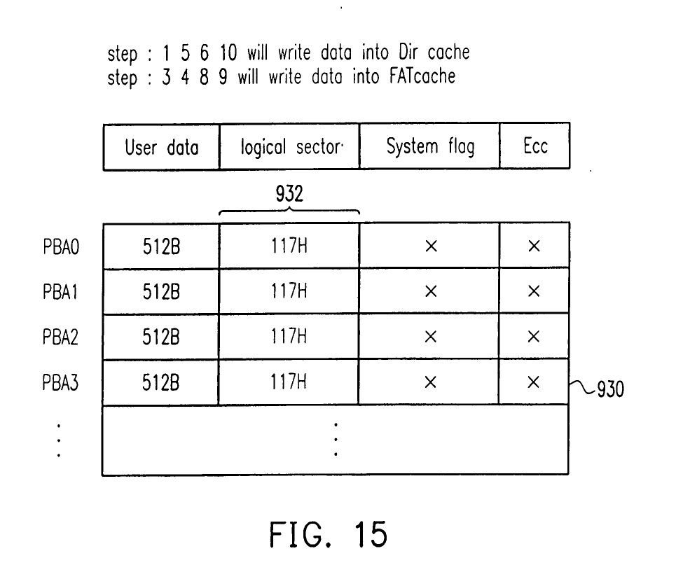

FIG. 15 is a drawing, schematically illustrating a status of the directory cache, according to one preferred embodiment of this invention. In FIG. 15, the physical sector structure of the directory cache 930 which is composed of at least one physical block including multiple physical sectors (PBA0, PBA1, . . . ), can be arranged to include the user data, logical sector 932 and other fields, such as system flag and Ecc. According the write algorithm of FIG. 13 or FIG. 14, the logical sector 117h for storing updated directory entry will be written into the directory cache 930. Referring to FIG. 10 also, the steps of 1, 5, 6, and 10 will write directory entry data into physical sector address PBA0, PBA1, PBA2, and PBA3, respectively.

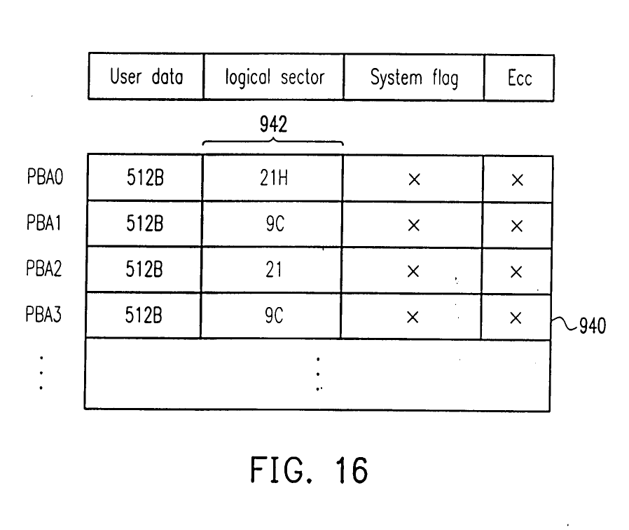

FIG. 16 is a drawing, schematically illustrating a status of the FAT cache or the corresponding cache, according to one preferred embodiment of this invention. In FIG. 16, the physical sector structure of the FAT cache 940 which is composed of at least one physical block including multiple physical sectors (PBA0, PBA1, . . . ), can be arranged to include the user data, logical sector 942 and other fields, such as system flag and Ecc. According to the write algorithm of FIG. 12 or FIG. 14, the steps of 3, 4, 8, and 9 in FIG. 10 will write FAT data into physical sector address PBA0, PBA1, PBA2, and PBA3, respectively.

In conclusions, the invention has introduced the specific cache area, such as the FAT cache, directory cache or the corresponding cache. Also, the control unit provides a proprietary write algorithm by using the specific cache area so that the swap action is not always necessary for each time of the random write. This can effectively improve the writing speed to the nonvolatile memory storage device.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

1. A method for organizing a writing operation to a nonvolatile memory, the method comprising:
setting a specific cache area, into which a specific data belonging to a specific group of logical blocks is to be written;
determining whether or not the writing operation is a random write, if the writing operation is the random write, then comprising the following steps:
determining whether or not the writing operation is to write a data that is belonging to the specific group of logical blocks; and
writing the data into the specific cache area if the data is belonging to the specific group of logical blocks;
wherein a swap action between a data block and a writing block can be avoided during a random write operation.

2. The method of claim 1, wherein in the step of setting the specific cache area, the specific cache area includes a FAT cache for storing a FAT-like data.

3. The method of claim 1, wherein in the step of setting the specific cache area, the specific cache area includes a corresponding cache for storing the data belonging to the specific group of logical blocks.

4. The method of claim 1, further comprising if the writing operation is not the random write, then directly writing the data into the writing block.

5. The method of claim 1, further comprising if the writing operation is to write the data that is not belonging to the specific group of logical blocks, then performing the swap action and writing the data into a new allocated writing block.

6. A method for organizing a writing operation to a nonvolatile memory, the method comprising:
setting a specific cache area;
determining whether or not the writing operation is a random write, if the writing operation is the random write, then comprising the following steps:
determining whether or not a sector count of a data to be written is less than a predetermined number; and
writing the data into the specific cache area if the sector count of the data is less than the predetermined number;
wherein a swap action between a data block and a writing block can be avoided during a random write operation.

7. The method of claim 6, wherein in the step of setting the specific cache area, the specific cache area includes a directory cache for storing a directory-like data.

8. The method of claim 6, further comprising if the writing operation is not the random write, then directly writing the data into the writing block.

9. The method of claim 6, further comprising if the sector count of the data is not less than the predetermined number, then performing the swap action and writing the data into a new allocated writing block.

10. A method for organizing a writing operation to a nonvolatile memory, the method comprising:
setting a specific cache area;
determining whether or not the writing operation is a random write, if the writing operation is the random write, then comprising the following steps:
determining whether or not the writing operation is to write a data that is belonging to the specific group of logical blocks;
writing the data into the specific cache area if the data is belonging to the specific group of logical blocks;
determining whether or not a sector count of the data to be written is less than a predetermined number; and
writing the data into the specific cache area if the sector count of the data is less than the predetermined number;
wherein a swap action between a data block and a writing block can be avoided during a random write operation.

11. The method of claim 10, wherein in the step of setting the specific cache area, the specific cache area includes a FAT cache for storing a directory-like data.

12. The method of claim 10, wherein in the step of setting the specific cache area, the specific cache area includes a directory cache for storing a directory-like data.

13. The method of claim 10, wherein in the step of setting the specific cache area, the specific cache area includes a corresponding cache for storing the data belonging to the specific group of logical blocks.

14. A nonvolatile memory unit, having a storage structure, within a memory storage device which can be accessed by a host, the nonvolatile memory unit including a plurality of physical blocks, used and managed by a control unit within the memory storage device, the control unit organizing the physical blocks into the storage structure, comprising:
a data block, composed of at least one physical block, and used to store a corresponding logical block information;
a writing block, serving as a temporary block for the data block;
optionally a spare block, which can be allocated to become the writing block; and
at least one specific cache area, which is used for writing-into a cached data, wherein the cached data includes a specific data belonging to a specific logical block, whereby a swap action for this time of writing the specific data is not always necessary even if a random write is desired.

15. The nonvolatile memory unit of claim 14, wherein the at least one specific cache area includes a FAT cache.

16. The nonvolatile memory unit of claim 14, wherein the at least one specific cache area includes a corresponding cache.

17. A nonvolatile memory unit, having a storage structure, within a memory storage device, which can be accessed by a host, the nonvolatile memory unit including a plurality of physical blocks, used and managed by a control unit within the memory storage device, the control unit organizing the physical blocks into a plurality of types of blocks, comprising:
a data block, composed of at least one physical block, and used to store a corresponding logical block information;
a writing block, serving as a temporary block for the data block;
optionally a spare block, which can be allocated to become the writing block; and
at least one specific cache area, which is used for writing-into a cached data, wherein a sector count of the cached data is less than a predetermined number, whereby a swap action for this time of writing the specific data is not always necessary even if a random write is desired.

18. The nonvolatile memory unit of claim 17, wherein the at least one specific cache area includes a directory cache.
